(19) United States
(12) Patent Application Publication
(10) Pub. No.: US 2005/0096212 A1
(43) Pub. Date: May 5, 2005

(54) Catalyst for the conversion of carbon monoxide

(76) Inventors: Hiroshi Takeda, Toyama (JP); Troy L. Walsh, Louisville, KY (US); Jon P. Wagner, Louisville, KY (US)

Correspondence Address: SUD-CHEMIE INC., 1600 WEST HILL STREET, LOUISVILLE, KY, 40210, US

(21) Appl. No.: 10/740,144

(22) Filed: Dec. 18, 2003

Related U.S. Application Data
(60) Provisional application No. 60/516,230, filed on Oct. 31, 2003.

(51) Int. Cl. B01J 29/06

(52) U.S. Cl. 502/66; 502/64

(57) ABSTRACT

A catalyst for the conversion of carbon monoxide comprising a support having a predetermined pore size and a metal capable of forming a metal carbonyl species is described. In one embodiment, the catalyst of the present invention comprises a mordenite, beta, or faujasite support and ruthenium metal.

### CROSS-REFERENCE TO RELATED APPLICATIONS

The present application is related to U.S. Provisional Application Ser. No. 60/516,230 filed on Oct. 31, 2003 and incorporated herein in its entirety by reference.

### BACKGROUND OF THE INVENTION

1. Field of the Invention

The present invention is for a catalyst for the conversion of carbon monoxide. More specifically, this invention relates to catalyst comprising a support having a predetermined pore size and a metal capable of forming a metal carbonyl species. In one embodiment, the catalyst of the present invention comprises a mordenite, beta, or faujasite support and ruthenium metal.

2. Description of the Related Art

In a fuel cell, such as a Polymer Electrolyte Membrane Fuel Cell (PEMFC) stack, chemical energy of a fuel is converted into electrical energy. Typically, the fuel used is a hydrogen rich gas supplied to the fuel cell by a fuel processor. However, the gas from the fuel processor may further comprise unconverted hydrocarbon, water, carbon dioxide and carbon monoxide. The carbon monoxide, in particular, is detrimental to the PEMFC stack because the carbon monoxide can poison the noble metal electrodes utilized by the fuel cells, thereby reducing the electrical output.

Preferably, the CO concentration for a fuel cell feed should be at a level below about 100 ppm, and more preferably to a level of less than about 50 ppm. However, as received from the fuel processor, the CO concentrations may be in excess of about 1 wt %, thus requiring further reduction of CO concentration. Some typical methods for reducing the CO concentration include selective catalytic oxidation of CO, pressure swing adsorption, hydrogen separation by membrane, and selective methanation of CO.

Selective catalytic oxidation of CO (Eq. 1) is a well-known process for reducing the CO concentration for fuel cells. But, oxidation of hydrogen (Eq. 2) is a competitive reaction.
½O₂+CO→CO₂ Eq. 1
½O₂+H₂→H₂O Eq. 2

Thus, in order to maximize the concentration of hydrogen gas and minimize the concentration of carbon monoxide, it is necessary to have reaction conditions wherein Eq. 1 is favored over Eq. 2. One option for achieving this is to have a highly specific catalyst for the oxidation of carbon monoxide and to limit the oxygen concentration so that the oxygen is consumed primarily for the production of carbon dioxide. Theoretically, this is achievable, but in practice there are wide swings in the CO concentrations produced by the fuel processor and it can be difficult to adjust the oxygen input to track the CO concentration. Because the CO is more detrimental to the fuel cell than water, it is typical for excess oxygen to be fed into the reactor thereby essentially ensuring that the CO will be converted to CO₂. The disadvantage is that significant quantities of H₂ are converted to water by operating in this manner.

Pressure swing adsorption is an industrially proven technology, but it requires relatively high pressure operation. Thus, while this process may be effective for use in larger fuel cells, it is not practical at this time for smaller fuel cells.

Hydrogen separation by membrane is effective for separating hydrogen from carbon monoxide. But the process requires a substantial pressure drop to effect the separation, and the cost and durability of the membranes still must be proven.

Selective methanation (Eq. 3) is a process whereby carbon monoxide is reacted with hydrogen in the presence of a catalyst to produce methane and water and methanation of carbon dioxide is minimized. Commonly used in ammonia plants, total carbon oxide methanation is known to reduce carbon monoxide and carbon dioxide concentrations to levels as low as about 5 ppmv to 10 ppmv, and the industrial catalysts are not selective. However, in most fuel cell applications, the selective methanation reaction is accompanied by a reverse water-gas-shift reaction (Eq. 4), which also is generally facilitated by a catalyst.

Thus, while the CO concentration is being reduced through methanation, additional carbon monoxide is formed from the carbon dioxide present to maintain the equilibrium of the water-gas-shift reaction.
CO+3H₂→CH₄+H₂O Eq. 3
CO₂+H₂←→CO+H₂O Eq. 4
Under the proper reaction conditions and with a non-selective methanation catalyst, the CO₂ may be methanated as shown in Eq. 5.
CO₂+4H₂→CH₄+2H₂O Eq. 5
But, this is generally an undesirable reaction because it further consumes H₂ and the CO₂ methanation is normally accompanied by a temperature rise in the reactor that can lead to “run-away” conditions. Considering that the carbon dioxide concentration is greater than 10 times that of carbon monoxide, achieving selectivity is not thermodynamically favorable. Thus, it would be advantageous to have a catalyst that is highly selective for CO methanation, essentially suppresses CO₂ methanation and does not facilitate the conversion of CO₂ to CO through the water-gas-shift reaction.

In the prior art methanation processes, precious metals supported on non-zeolitic materials, such as Al₂O₃, SiO₂, and TiO₂, have been used as catalysts in the selective methanation of CO (see, for example, U.S. Pat. No. 3,615,164 and U.S. Pat. Pub. No. 2003/0086866). For example, in Patent Number WO 01/64337, ruthenium (Ru) on a carrier base support of Al₂O₃, TiO₂, SiO₂, ZrO₂, or Al₂O₃—TiO₂ with egg-shell structure is taught to reduce the CO to concentrations of about 800 ppm with 70-80% selectivity under an atmosphere of CO at 0.6%, CO₂ at 15%, H₂ at 64.4%, H₂O at 20% and GHSV=10,000 H⁻¹. However, for an efficient PEMFC power system, the CO concentration should be less than about 100 ppm, and preferably equal to or less than about 50 ppm. Since the CO concentration from the selective methanation processes using the prior art catalysts are significantly higher than the desired maximum concentration for a PEMFC stack, these catalysts cannot be practically used in PEMFC power systems.

Thus, it would be advantageous to have a catalyst that is highly selective for CO methanation, essentially suppresses CO₂ methanation and does not facilitate the conversion of CO₂ to CO through the water-gas-shift reaction.

### SUMMARY OF THE INVENTION

The catalyst of the present invention comprises a metal capable of forming a metal-carbonyl species on a support having a predetermined pore size. More specifically, the catalyst comprises a metal selected from the group consisting of ruthenium, rhodium, nickel, iron, cobalt, rhenium, palladium, lead, tin and other metals that form a metal-carbonyl species on a support having a regular lattice structure and a predetermined pore diameter of sufficient dimensions to accommodate the carbonylated metal species. In an embodiment, the metal is ruthenium and the support is selected from mordenite, beta-zeolite or faujasite and has a pore diameter of greater than about 6.3 Å, and a pore volume in the range of from about 0.3 cm³/g to about 1.0 cm³/g. An inert binder, such as alumina, γ-Al₂O₃, SiO₂, ZrO₂, TiO₂ or pseudo-boehmite, may optionally be added to the catalyst. The catalyst efficiently facilitates the selective hydrogenation of carbon monoxide using H₂ that is present in the reformate and reduces the concentration of the CO to levels equal to or less than about 50 ppm.

The present invention further includes a process for CO “polishing”, whereby the concentration of CO in a mixture of gases containing hydrogen, hydrocarbons, carbon dioxide, carbon monoxide and water is removed or substantially reduced. Particularly, this invention is directed to a method of selective methanation whereby carbon monoxide is reduced to a concentration level such that the residual hydrogen is suitable for use as a fuel in a fuel cell and the overall efficiency of the PEMFC power system is improved.

### BRIEF DESCRIPTION OF THE FIGURES

FIG. 1 is graphical depictions of the carbon monoxide reduction performance of a catalyst made in accordance with the present invention and comprising 2 wt % ruthenium as compared to a catalyst made in accordance with the present invention and comprising 4 wt % ruthenium.

FIGS. 2A-2C are graphical depictions of the carbon monoxide reduction performance of catalysts made in accordance with the present invention and comprising γ-Al₂O₃, pseudo-boehmite and SiO₂, respectively, as the binder.

### DETAILED DESCRIPTION OF THE PREFERRED EMBODIMENT

The catalyst of the present invention has demonstrated benefits in facilitating the carbon oxide methanation reactions in small fuel cells. In general terms, the catalyst comprises a metal capable of forming a metal-carbonyl species on a support having a predetermined pore size of sufficient dimensions to allow the pore to accommodate a fully carbonylated metal complex. As is known in the art, some typical supports for catalysts are crystalline alumino-silicate materials. Among the metals known in the art to form stable metal-carbonyl complexes are ruthenium, rhodium, nickel, iron, cobalt, rhenium, palladium, lead and tin, as an exemplary group. Optionally, a binder, such as alumina, γ-Al₂O₃, SiO₂, ZrO₂, TiO₂ or pseudo-boehmite, may be added to the catalyst.

The present invention will be described herein through, without limitation, exemplary embodiments, figures and examples. Any embodiments, figures, examples and related data presented herein are merely to exemplify the principles of the invention, and are not intended to limit the scope of the invention.

The support of the catalyst of the present invention comprises a crystalline alumino-silicate having a predetermined pore size. More specifically, the crystalline alumino-silicate can be a molecular sieve, beta-zeolite, mordenite, faujasite or any other alumino-silicate with a regular lattice structure. Other supports that also have regular lattice structures and essentially consistent pore sizes that may be used in place of the alumino-silicate for the catalyst of the present invention include alumina, titania, ceria, zirconia and combinations thereof.

Because it is believed that the methanation reaction occurs within the support pore, the pore must be of sufficient dimensions to accommodate a fully carbonylated metal complex, and thus, the pore size requirement will vary depending on the metal species selected for the catalyst. However, it has generally been observed that if the pore size is smaller than or is significantly larger than the dimensions of the fully carbonylated metal species, the resulting catalyst does not show the desired selectivity for carbon monoxide methanation. A representative catalyst made in accordance with the present invention has a pore diameter of at least 6.3 Å, and preferably is not significantly larger than about 10 Å.

The metal of the catalyst of the present invention must be capable of forming a metal-carbonyl species. For the purpose of the development, it is not necessary that the metal be capable of forming a fully-carbonylated complexes, e.g. wherein each ligand is a carbonyl group. Rather, a “fully-carbonylated” complex—for the purpose of calculating the volume needed within the support pore—is defined herein as the metal complex with the maximum number of carbon monoxide ligands that the metal prefers to accommodate in its lowest energy state. The metal is preferably selected from the group consisting of ruthenium, rhodium, platinum, palladium, rhenium, nickel, iron, cobalt, lead, tin, silver, iridium, gold, copper, manganese, zinc, zirconium, molybdenum, other metals that form a metal-carbonyl species and combinations thereof. As delivered to the catalyst, the metal may be a base metal or it may be a metal oxide complex.

The metal may be added to the support by any means known in the art for intercalating the metal into the support pores, such as, without limitation, impregnation, incipient wetness method, immersion and spraying. The embodiments presented herein add the metal through impregnation for exemplary purposes only. Although not a requirement to practice the invention, it is recommended that the metal source be free of typically recognized poisons, such as sulfur, chlorine, sodium, bromine, iodine or combinations thereof. Acceptable catalyst can be prepared using metal sources that include such poisons, but care must be taken to wash the poisons from the catalyst during production of the catalyst.

In an embodiment of the present invention, the support is a crystalline alumino-silicate selected from mordenite, beta-zeolite or faujasite. The support has a pore diameter of greater than about 6.3 Å, and a pore volume in the range of from about 0.3 cm³/g to about 1.0 cm³/g, and preferably in the range of 0.5 cm³/g to about 0.8 cm³/g. Ruthenium is impregnated on the support so as to deliver a concentration of from about 0.5 wt % Ru to about 4.5 wt % Ru, based on the total weight of the catalyst including the ruthenium. Some recommended sources of ruthenium include, without limitation, Ru(NO)(NO₃)ₓ(OH)_{y}, Ru(NO₂)₂(NO₃)₂, Ru(NO₃)₃, RuCl₃, Ru(CH₃COO₃), (NH₄)₂RuCl₆, [Ru(NH₃)₆]Cl₃Ru(NO)Cl₃, and Ru₃(CO)₁₂. Optionally, the catalyst further comprises the binder pseudo-boehmite at a loading of about 20 wt %, including the weight of the binder. The binder may be added by dry-mixing with the support and adding water to obtain the desired plasticity, or by other methods known in the art.

The metal-impregnated support is oven-dried and then calcined at temperatures of from about 250° C. to about 550° C. It has been observed that for a Ru/H-MOR-20/pseudo-boehmite catalyst the functional temperature range for the catalyst widens as the calcination temperature increases from about 250° C. to about 475° C. As the calcination temperature continues to increase, the functional temperature range rapidly decreases. Because different catalyst formulations will be affected differently by calcination, optimal calcination temperatures will be catalyst specific.

The catalyst may be used in an exemplary process for removing or substantially reducing the quantity of carbon monoxide in a mixture of gases containing hydrogen, carbon dioxide, carbon monoxide, and water. The process involves passing a mixture of gases over the catalyst in a reaction zone having a temperature below the temperature at which the shift reaction occurs and above the temperature at which the selective methanation of carbon monoxide occurs. The target performance of carbon monoxide (CO) selective methanation catalyst is a carbon monoxide (CO) exit of less than about 50 ppm and a carbon monoxide (CO) methanation selectivity of greater than about 50%.

The following examples illustrate and explain the present invention, but are not to be taken as limiting the present invention in any regard.

### EXAMPLE 1

A catalyst is prepared by impregnating a H-MOR-20 support having pore volume of about 0.5 cm³/g to about 0.8 cm³/g and having a pore diameter of about 6.5 Å (available from Süd-Chemie, Inc.) with a ruthenium nitrosylnitrate (Ru(NO)(NO₃)ₓ(OH)_{y}) solution (9.5-10.1 wt % Ru; Colonial Metals, Inc., Catalog No. 8037) such that the resulting catalyst has about 2.0 wt % Ru. The resulting solution pH is lowered to about 0.8 by adding deionized water. The impregnated zeolite is oven-dried at about 110° C. for eight to fifteen hours, and is then calcined at from about 450° C. to about 475° C. for about two hours, at a heating rate of about 10° C.·min⁻¹.

### EXAMPLE 2

A catalyst is prepared following the method of Example 1 except that the H-MOR-20 is replaced by a CeO₂ support having pore volume of about 0.10 cm³/g to about 0.18 cm³/g and having a pore diameter of about 70 Å (available from Rhodia Electronics and Catalysts).

### EXAMPLE 3

A catalyst is prepared following the method of Example 1 except that the H-MOR-20 is replaced by a ceria zirconia oxide support having pore volume of about 0.10 cm³/g to about 0.16 cm³/g and having a pore diameter of about 130 Å (available from Advanced Materials Resources).

### EXAMPLE 4

A catalyst is prepared following the method of Example 1 except that the H-MOR-20 is replaced by an α-Al₂O₃ support having pore volume of about 0.17 cm³/g to about 0.25 cm³/g and having a pore diameter of about 40 Å (such as A-13 available from Alcoa).

### EXAMPLE 5

A catalyst is prepared following the method of Example 1 except that the H-MOR-20 is replaced by an anatase TiO₂ support having pore volume of about 0.16 cm³/g to about 0.28 cm³/g and having a pore diameter of about 155 Å (such as P25 available from Degussa).

### EXAMPLE 6

A catalyst is prepared following the method of Example 1 except that the H-MOR-20 is replaced by a rutile TiO₂ support having pore volume of about 0.20 cm³/g to about 0.38 cm³/g and having a pore diameter of about 300 Å (such as MT-500B available from Tayca).

### EXAMPLE 7

A catalyst is prepared following the method of Example 1 except that the H-MOR-20 is replaced by a ZrO₂ support having pore volume of about 0.17 cm³/g to about 0.25 cm³/g and having a pore diameter of about 95 Å (such as AMR-02-9-6 available from Advanced Materials Resources).

### EXAMPLE 8

A catalyst is prepared following the method of Example 1 except that the H-MOR-20 is replaced by a MFI support having pore volume of about 0.40 cm³/g to about 0.82 cm³/g and having a pore diameter of about 5.3 Å (available from Süd-Chemie, Inc.).

The catalyst of the present invention may comprise any support that has a regular lattice structure and essentially consistent pore diameter of sufficient dimensions to accommodate a fully carbonylated metal complex. It has been observed that the catalysts of Examples 1, 5 and 6 are more efficient for the conversion of carbon monoxide than the catalysts of Examples 2, 3, 4, 7 and 8.

### EXAMPLE 9

A catalyst is prepared following the method of Example 1 except that the concentration of (Ru(NO)(NO₃)ₓ(OH)_{y}) solution is increased to deliver about 4.0 wt % Ru to the finished catalyst.

### EXAMPLE 10

A catalyst is prepared following the method of Example 1 except that the concentration of (Ru(NO)(NO₃)ₓ(OH)_{y}) solution is increased to deliver about 0.3 wt % Ru to the finished catalyst.

### EXAMPLE 11

A catalyst is prepared following the method of Example 1 except that the concentration of (Ru(NO)(NO₃)ₓ(OH)_{y}) solution is increased to deliver about 0.75 wt % Ru to the finished catalyst.

### EXAMPLE 12

A catalyst is prepared following the method of Example 1 except that the concentration of (Ru(NO)(NO₃)ₓ(OH)_{y}) solution is increased to deliver about 1.5 wt % Ru to the finished catalyst.

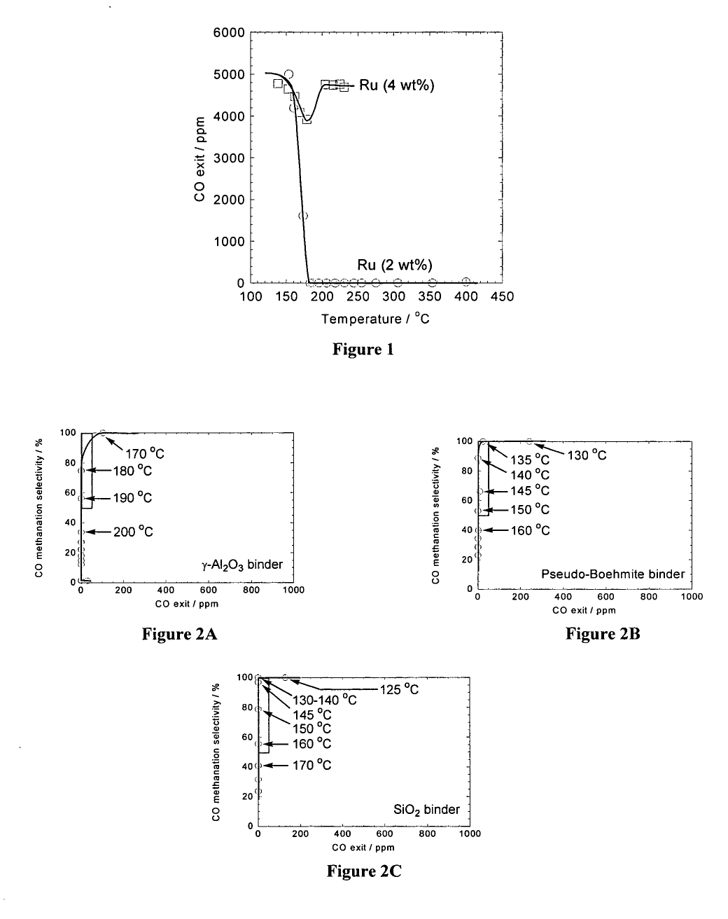

The catalyst of the present invention may comprise from about 0.5 wt % to about 4.5 wt % Ru. However, as shown in FIG. 1, based on ion-exchange studies using the catalysts of Example 1 and Example 9, ruthenium loading on a zeolite of about 2.0 wt % is more efficient for carbon monoxide reduction than a ruthenium loading of about 4.0 wt %. Specifically, it is believed that at a ruthenium loading of about 2.0 wt %, about half the catalytic sites remain available for the hydrogenation of carbon monoxide, whereas at higher loading levels, the availability of reaction sites is decreased and the reactivity rate decreases.

### EXAMPLE 13

A catalyst is prepared following the method of Example 1 except that a binder, γ-Al₂O₃, is added to the catalyst during preparation. The binder is added by dry-mixing with the support. After about 20 minutes, water is added until the mixture obtains the desired plasticity. The resulting catalyst has a concentration of about 20 wt % γ-Al₂O₃, including the weight of the binder.

### EXAMPLE 14

A catalyst is prepared following the method of Example 1 except that the γ-Al₂O₃ is replaced by pseudo-boehmite at a concentration of about 20 wt %, including the weight of the binder.

### EXAMPLE 15

A catalyst is prepared following the method of Example 1 except that the γ-Al₂O₃ is replaced by SiO₂ at a concentration of about 20 wt %, including the weight of the binder.

The choice of binder can affect the performance of the finished catalyst. For example, as shown in FIGS. 2A-2C, silica and pseudo-boehmite binders improved the performance of the catalyst to a greater degree than γ-alumina.

### EXAMPLES 16-18

The catalysts prepared according to Examples 13-15, respectively, are performance tested by subjecting the catalysts to a feed stream comprising 0.5% CO, 20.0% CO₂, 75.0% H₂, and 4.5% N₂ with steam/dry gas at 0.25 mol·mol⁻¹ and a reaction pressure of 345 kPa. The space velocity is varied up to about 20,000 hr⁻¹. It is observed that the catalysts' efficiency at varying space velocities is related to the metal loading. When the GHSV is less than 2,000 hr⁻¹, a ruthenium loading of about 0.3 wt % is essentially optimal, but at a GHSV of about 5,000 hr⁻¹ the catalyst is more efficient with a ruthenium loading of about 0.75 wt %, and for a GHSV of about 10,000 hr⁻¹ the ruthenium loading is preferably about 1.5 wt %.

It is understood that variations may be made which would fall within the scope of this development. For example, although the catalysts of the present invention are intended for use as selective methanation catalysts for the conversion of carbon monoxide for fuel cell applications, it is anticipated that these catalysts could be used in other applications requiring highly selective carbon oxide methanation catalysts

1. A catalyst for carbon oxide methanation reactions for fuel cells comprising a metal selected from the group consisting of ruthenium, rhodium, nickel and combinations thereof, on a support selected from the group consisting of a beta-zeolite, mordenite and faujasite.

2. The catalyst of claim 1 further comprising an inert binder.

3. The catalyst of claim 2 wherein the binder is selected from the group consisting of alumina, γ-Al₂O₃, SiO₂, ZrO₂, TiO₂ or pseudo-boehmite.

4. The catalyst of claim 1 wherein the metal is added to the support through impregnation, incipient wetness method, immersion and spraying.

5. The catalyst of claim 4 wherein the ruthenium is added to the support through impregnation.

6. The catalyst of claim 5 wherein the ruthenium impregnated on the support so as to deliver a concentration of from about 0.5 wt % Ru to about 4.5 wt % Ru, based on the total weight of the catalyst including the ruthenium.

7. A catalyst for carbon oxide methanation reactions for fuel cells comprising a metal capable of forming a metal-carbonyl species on a support having a pore volume in the range of from about 0.3 cm³/g to about 1.0 cm³/g.

8. A catalyst for carbon oxide methanation reactions for fuel cells comprising ruthenium impregnated on a support selected from the group consisting of a beta-zeolite, mordenite and faujasite, wherein the ruthenium is impregnated on the support so as to deliver a concentration of from about 0.5 wt % Ru to about 4.5 wt % Ru, based on the total weight of the catalyst including the ruthenium.

9. The catalyst of claim 8 further comprising an inert binder.

10. The catalyst of claim 9 wherein the binder is selected from the group consisting of alumina, γ-Al₂O₃, SiO₂, ZrO₂, TiO₂ or pseudo-boehmite.

11. A catalyst for carbon oxide methanation reactions for fuel cells prepared by reacting a metal selected from the group consisting of ruthenium, rhodium, nickel and combinations thereof, with a support having a pore volume in the range of from about 0.3 cm³/g to about 1.0 cm³/g, and then oven-drying the metal-treated support and then calcining the metal-treated support.

12. The catalyst of claim 11 wherein the support is selected from the group consisting of a crystalline alumino-silicate, a molecular sieve, beta-zeolite, mordenite, faujasite, any other alumino-silicate with a regular lattice structure, alumina, titania, ceria, zirconia and combinations thereof.

13. The catalyst of claim 11 further comprising a binder selected from the group consisting of alumina, γ-Al₂O₃, SiO₂, ZrO₂, TiO₂ and pseudo-boehmite, wherein the binder is added by mixing with the support.

14. The catalyst of claim 11 wherein the metal is added to the support through impregnation, incipient wetness method, immersion and spraying.

15. The catalyst of claim 11 wherein the metal is ruthenium impregnated on the support so as to deliver a concentration of from about 0.5 wt % Ru to about 4.5 wt % Ru, based on the total weight of the catalyst including the ruthenium.

16. A catalyst for carbon oxide methanation reactions for fuel cells prepared by impregnating ruthenium on a support so as to deliver a concentration of from about 0.5 wt % Ru to about 4.5 wt % Ru, based on the total weight of the catalyst including the ruthenium, wherein the support is selected from the group consisting of a beta-zeolite, mordenite and faujasite, and then oven-drying the impregnated support at a temperature of about 110° C., and then calcining the impregnated support at a temperature of from about 250° C. to about 550° C.

17. The catalyst of claim 16 wherein the support has a pore diameter of greater than about 6.3 Å and a pore volume in the range of from about 0.3 cm³/g to about 1.0 cm³/g.

18. The catalyst of claim 16 wherein the catalyst further comprises a binder selected from the group consisting of alumina, γ-Al₂O₃, SiO₂, ZrO₂, TiO₂ and pseudo-boehmite, at a loading of about 20 wt %, including the weight of the binder, wherein the binder is added by mixing with the support.

19. The catalyst of claim 16 wherein the impregnated support is calcined at about 475° C. for about two hours.

20. The catalyst of claim 16 wherein the impregnated support is oven-dried for from about eight hours to about fifteen hours.
